(19) United States
(12) Patent Application Publication
(10) Pub. No.: US 2001/0054952 A1
(43) Pub. Date: Dec. 27, 2001

(54) Automatic port operation

(76) Inventors: Tejas B. Desai, Sterling Heights, MI (US); Susan A. Johnson, Rochester, MI (US)

Correspondence Address: LAURA M. SLENZAK, SIEMENS CORPORATION, 186 WOOD AVENUE SOUTH, ISELIN, NJ, 08830, US

(21) Appl. No.: 09/874,598

(22) Filed: Jun. 5, 2001

Related U.S. Application Data
(60) Provisional application No. 60/213,006, filed on Jun. 21, 2000.
(60) Provisional application No. 60/230,966, filed on Sep. 7, 2000.

(51) Int. Cl. G08B 29/00

(52) U.S. Cl. 340/5.72; 340/5.64

(57) ABSTRACT

The vehicle port system comprises a first port secured by a first lock and at least a second port secured by a second lock. A control unit communicates with at least the first lock, thereby controlling actuation of at least the first lock. At least one proximity sensor communicates with the control unit and senses for an electronic key device. The control unit actuates the first lock without actuating the second lock when the at least one proximity sensor senses the electronic key device a predetermined distance from the first port.

This application claims priority to Provisional Patent Application Ser. No. 60/213,006 filed on Jun. 21, 2000 and Provisional Patent Application Ser. No. 60/230,966 filed on Sep. 7, 2000.

### BACKGROUND OF THE INVENTION

This invention relates to a method and system for passive vehicle entry that automatically opens a port, such as a door or trunk at an appropriate time.

Many vehicles employ remote entry systems that permit a vehicle operator to lock and unlock the doors and trunk of the vehicle. Such systems usually comprise a transmitter located in a key device, say a key fob, and a receiver located in the vehicle. Upon activation by the driver, the key device fob transmits a key code to the receiver. A control unit then compares the key code to a security code to determine whether the key code matches the security code. In the event of a match, the control unit locks or unlocks the vehicle.

Such systems require the driver to manually activate the transmitter, providing less convenience of operation. When the driver's hands are occupied, such as when carrying bags, the driver must free his hands to lock and unlock the vehicle. This limitation is undesirable.

Passive systems do exist that permit the driver to lock and unlock the vehicle. Such systems have sensors located adjacent a car's door handle that communicate with a control unit in the car. When the control unit senses the lifting of the handle, the control unit sends a challenge to a key device carried by the individual to determine whether the individual is authorized to unlock the door. If so, the control unit unlocks the vehicle.

In addition to requiring the use of a hand, such systems typically unlock all of the doors of the vehicle at the same time, permitting access to the vehicle beyond what may be desired by the driver. For example, a driver intending to open only the driver side door must also allow the other doors of the vehicle to be unlocked, thereby decreasing vehicle security. Moreover, because current passive entry systems only unlock the vehicle's doors, a driver must still manually lock the vehicle's ports if he chooses to leave the vehicle.

This problem has particular significance for delivery trucks. A delivery truck driver may frequently access the cargo bay of a truck. Generally, the driver must manually lock and unlock as well as open and close this bay door frequently. This manual operation makes the driver inefficient. Drivers have frequently left the cargo door unlocked while making a delivery to avoid frequently locking and unlocking the door, thereby increasing the risk of a stolen package.

Also, current entry systems of a vehicle do not open and close automatically the doors of the vehicle. Accordingly, a driver must still manually open and close the doors of the vehicle. For example, if the driver wishes to unload groceries in the back seat of the vehicle, he must still free a hand to open the door.

A need therefore exists for an automatic door and trunk system that selectively locks and unlocks and opens and closes the doors and trunks of a vehicle.

### SUMMARY OF THE INVENTION

The present invention selectively and automatically locks and unlocks as well as closes and opens selected ports of a vehicle. For purpose of this application, “port” should be interpreted to include doors, including cargo doors, trunks, and any other closure. In one feature, the system comprises a first port, such as a door or trunk, secured by a first lock and at least a second port secured by a second lock. At least one proximity sensor communicates with a control unit that, unlike current systems, separately actuates each lock between a locked and unlocked position. When the proximity sensor senses an electronic key device to be within a set distance from the first port, the control unit actuates the first lock without actuating the second lock. When the proximity sensor senses the electronic key device to be within a set distance from the second port, the control unit actuates the second lock without actuating the first lock. The control unit may lock or unlock the lock, depending on whether the operator is moving toward the door or away from the door. Also, there may be two set distances of detection for each proximity sensor: one distance away from the port that if crossed the door unlocks and another distance further away from the port that if crossed the door locks. A low frequency radio transmitter and receiver is preferably used as the proximity sensor.

For security, the electronic key device may transmit a key code to the control unit, which then compares the key code to a security code. If the key code matches the security code, then the control unit may permit opening and closing of the locks. The electronic key device may transmit this key code upon activation and may stop transmitting this key code following the actuation of any one of the locks.

The control unit may also control a motorized port subsystem that automatically opens and closes the doors and trunk of the vehicle corresponding to the unlocking and locking of these ports. The doors and trunk are opened and closed when the electronic key device reaches a set distance from any one of the ports. Moreover, the control unit may permit actuation of the locks for just a set time period. The control unit may be reactivated or awakened subsequently.

A more simplified version of the system may involve a port secured by a lock on a vehicle. The control unit may control actuation of the lock and actuate this lock only when a proximity sensor detects the electronic key device a predetermined distance from the port. The port is automatically opened or closed in conjunction with the locking and unlocking of the lock. This version would thus permit a cargo driver to exit a vehicle and automatically unlock and open the cargo bay door when he reaches the predetermined distance. He may then retrieve his package and then leave vehicle. As he passes the predetermined distance, the cargo bay door would then automatically close and lock.

The method for controlling a vehicle port comprises the steps of electronically sensing for a key device a distance from a first vehicle port secured by a first lock and electronically sensing for the key device a distance from at least a second vehicle port secured by a second lock. The first lock is automatically actuated without actuating the second lock when the key device is sensed a predetermined distance from the first vehicle port. The second lock is automatically actuated without actuating the first lock when the key device is sensed a predetermined distance from the second vehicle port.

The invention thus permits an operator to lock and unlock and open and close the doors and trunk of a vehicle merely by walking away and toward the particularly port. A driver whose hands were filled with groceries could simply walk toward the trunk of the vehicle. The vehicle would then unlock and open automatically the trunk, permitting the driver to unload his groceries. As the driver walks toward the driver side door, the trunk automatically closes and locks while the driver side door unlocks and opens.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 shows an embodiment of the invention, including ports, locks, and control unit.

FIG. 2 shows the embodiment of FIG. 1 with one lock of two locks actuated.

FIG. 3 shows another embodiment of the invention, including a motorized port subsystem, following actuation of lock and opening of door.

FIG. 4 shows another embodiment of the invention, with a locking and unlocking distance illustrated.

FIG. 5 illustrates an embodiment of the electronic key device of the invention.

FIG. 6 shows a sliding door embodiment of the invention with port opened and lock unlocked.

FIG. 7 shows the sliding door embodiment of FIG. 7 with port closed and lock locked.

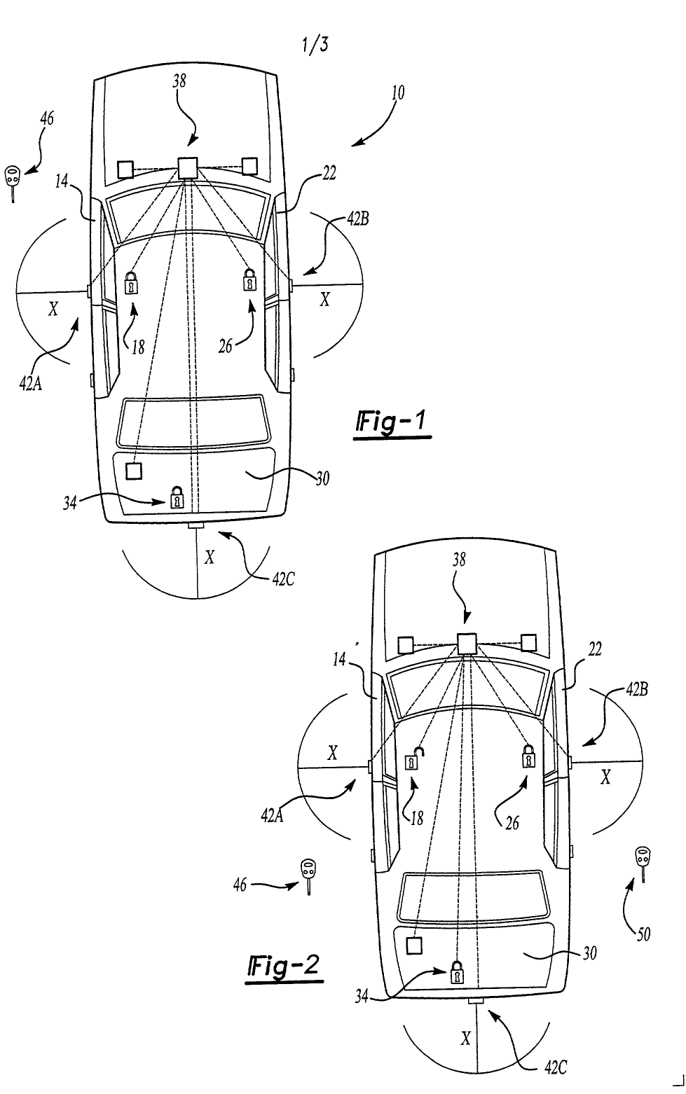

### DETAILED DESCRIPTION OF THE PREFERRED EMBODIMENT

The invention comprises both a system and method for controlling vehicle door and trunk operation. Vehicle port system 10 comprises first port 14 secured by first lock 18. A second port 22 is secured by second lock 26. Vehicle port system 10 may also include as a port, trunk 30 with third lock 34. Here, the ports are shown as a trunk and doors although the ports could comprise sliding doors, cargo bay doors, windows, or other access points of a vehicle. Control unit 38 communicates with each lock 18, 26, and 34 and separately actuates each lock between a locked and unlocked position. Hence, the actuation of one lock will not actuate the other lock or locks. The locks may be electronically controlled as known.

At least one proximity sensor, such as 42A, 42B, or 42C, communicates with control unit 38 and looks for electronic key device 46. Proximity sensor 42A, 42B, and 42C may be placed in the handle or latch of each port. Each proximity sensor 42A, 42B, and 42C is set to notify control unit 38 when electronic key device 46 is within a predetermined distance X, say one meter, from each port. This distance is typically within the detection distance of the proximity sensors and is generally adjustable. The distance X need not be the same distance for each port.

Control unit 38 is programmed to recognize the location of the proximity sensors and associate each sensor with a port. Proximity sensor 42A is associated with port 14, driver side door, proximity sensor 42B is associated with port 22, passenger side door, and proximity sensor 42C is associated with port 30, trunk. In this way, control unit 38 may determine which port the operator intends to open.

As seen in FIG. 2, once proximity sensor (42A, 42B, or 42C) detects the presence of electronic key device 46 within predetermined distance X, control unit 38 selectively actuates one of the locks without actuating the others. As seen in FIG. 2, control unit 38 actuates first lock 18 to open when proximity sensor 42A detects electronic key device 46 to be within predetermined distance X from first port 14. Also, control unit 38 will actuate second lock 26 when proximity sensor 42B senses electronic key device 46 to be a predetermined distance X from second port 22. Control unit 38 may actuate first lock 18 without actuating second lock 26 as shown in FIG. 2 when proximity sensor 42A senses electronic key device 46. Each lock is thus independently actuated from the other.

Moreover, as seen in FIG. 2, movement of electronic key device 50 outside of predetermined distance X serves to lock second lock 26. Accordingly, moving across distance X toward a particular door unlocks the door while moving away from the door across X locks the door. Doors 14 and 22 and trunk 34 may be locked and unlocked in this manner independently from each other.

The invention may be combined with known security features. Electronic key device 46 or 50 may contain and transmit a key code, which is sent to control unit 38. If key code matches a security code stored in control unit 38, then control unit 38 permits locking and unlocking of the system. For further protection against unauthorized access, electronic key device 46 or 50 may transmit the key code only when activated by operator. Additionally, control unit 38 may itself have a transmitter that sends a request to a receiver of electronic key device 46 to transmit key code. Indeed, if key code were also tied to a security code for a home security or other security system, control unit 38 could also cue electronic key device 46 to open automatically the door of a home or the gate of such a system once the operator passed the predetermined distance X. The operator could then lock his car and open the door to his home without ever touching his electronic key device 46.

The operator may provide authorization to electronic key device 46 or 50 to permit its response to any inquiry by control unit 38, activating the passive automatic port system only when desired. Electronic key device 46 or 50 may cease transmitting the key code following actuation of any one of the locks and thereby further limit the transmission of key code.

Proximity sensors 42A, 42B, and 42C preferably comprise a low frequency radio wave transmitter and receiver. Electronic key device 46 is attuned to the transmission frequency of proximity sensors 42A, 42B, and 42C by a receiver such as a transponder. When electronic key device 46 receives the transmission, electronic key device 46 responds by sending a key code to the particular proximity sensor, 42A, 42B, and 42C, which sends this key code to control unit 38. Now detecting the presence of electronic key device, control unit 38 then compares this key code to a security code, which may be stored in memory. If the key code matches the security code, control unit 38 permits the locking and unlocking of the particular lock associated with the particular proximity sensor.

Due to the use of low frequency radio waves, the effective range of communication between electronic key device 46 and the particular proximity sensor 42A, 42B, and 42C has a limited range or predetermined distance X, which may be set to say one meter from the particular sensor. Accordingly, as shown in FIG. 2, the presence of electronic key device 46 a predetermined distance X from port 14 will result in the transmission of key code only to proximity sensor 42A, not to proximity sensors 42B or 42C. In this way, control unit 38 may discern the particular location of electronic key device 46 in relation to each port.

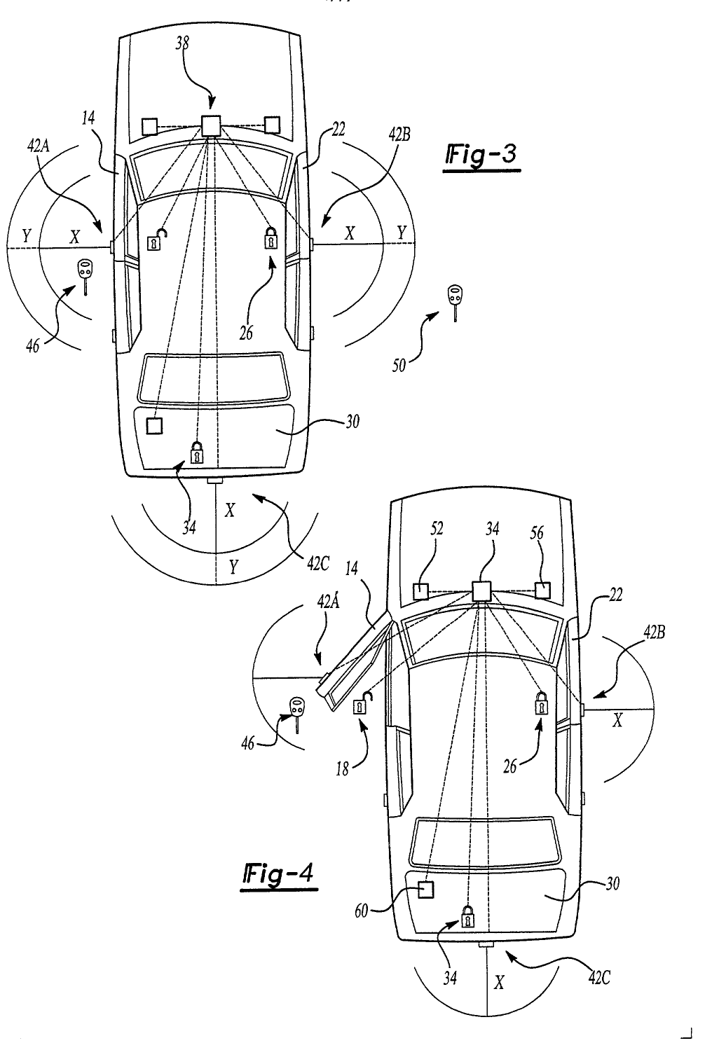

To a degree, the predetermined distance X may be adjusted. As known, the low frequency radio field generated by proximity sensor decreases in field strength moving away from the sensor. By adjusting the sensitivity of reception by electronic key device 46 or, alternatively, the predetermined threshold for triggering the device to transmit its key code, the predetermined distance X may be adjusted. Indeed, as seen in FIG. 3, the predetermined distance may actually comprise two distances: an unlocking distance X and a locking distance Y. In such an embodiment, the presence of electronic key device 46 within unlocking distance X unlocks lock 18. If electronic key device 50 moves beyond locking distance Y, then control unit 38 locks lock, say lock 26 as shown. Hence, by moving within distance X wherein said predetermined distance comprises a locking distance that locks any one of said locks if said electronic key device reaches said locking distance and an unlocking distance that unlocks any one of said locks if said electronic key device reaches said unlocking distance. This system permits control unit 38 to more accurately discern the intent of the driver. Control unit 38 may also be programmed to permit actuation of these locks only if the driver crosses these distances within a set period of time.

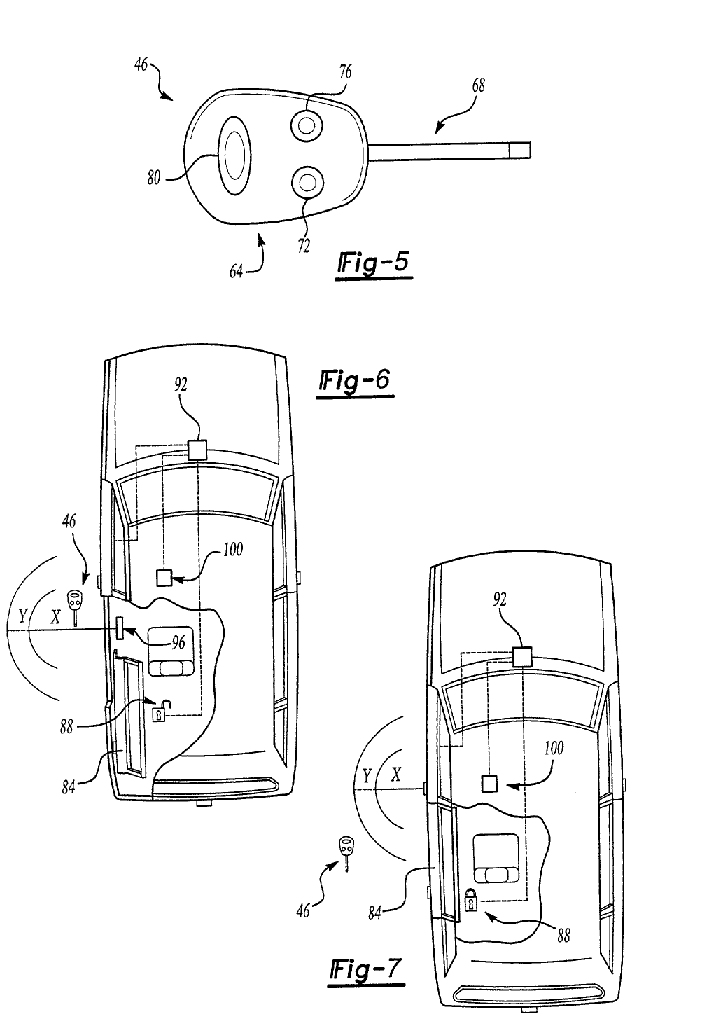

For example, control unit 38 could be set to unlock at a predetermined distance X, say one meter from a particular port, and set to lock at a predetermined distance of Y, say two meters from the port, to lock. If the driver walked away from the port beyond distance Y, the port automatically locks. If the driver returned to predetermined distance X within a predetermined amount of time, say five or fifteen minutes, the port would automatically unlock. However, beyond this predetermined amount of time, control unit 38 would stop automatic lock actuation. A driver would then have to reactivate passive port operation as further detailed below and shown in FIG. 5.

As shown in FIG. 4, the automatic port system may include a motorized port subsystem 52, 56, and 60 that automatically moves any one of the ports 14, 22, or 30. Here, electronic key device 46 moves within predetermined distance X. Lock 18 is unlocked and motorized port subsystem 52 automatically opens door 14. In the event electronic key device 46 moves away from port 14 and beyond predetermined distance X, then motorized port subsystem closes door and then subsequently locks lock 18. Automatic port system not only automatically and individually actuates each lock but also opens or closes each port. Such motorized systems are well within the skill of worker in the door opening art. A variety of mechanical and motor systems could be combined to achieve such opening. The details of how the motorized system works form no part of this invention, and instead it is the application of the control features with such a system which is inventive here.

Any of the foregoing embodiments may also be modified such that control unit 38 actuates the locks, 18, 26, and 34 only if electronic key device 46 is sensed by a predetermined time. Hence, if an operator exits the vehicle and moves beyond predetermined distance X, he will lock the lock. If the operator returns within a predetermined time, the door will unlock automatically. Beyond this time, the automatic port system is deactivated limiting consumption of power by the system on the vehicle's battery. The automatic port system may be reactivated by the operator who preauthorizes the system to permit passive entry.

Additionally, the automatic port system may also receive a “wake up” from another device such as a transmitter at a store checkout counter or other system that automatically primes the automatic port system when cued. For example, an operator could grocery shop beyond the predetermined time for control unit 38 to actively seek electronic key device 46. The presence of the operator at the checkout counter could automatically cue a transmitter in electronic key device 46 to “wake up” control unit 38 to commence searching for electronic key device 46. The operator would then simply walk to the trunk of the car, which would then open automatically when the operator and electronic key device 46 entered the predetermined distance X. In this way, the automatic port system is transparent to the operator and permits convenient unlocking and opening of the trunk.

FIG. 5 illustrates an embodiment of electronic key device 46, here shown as a key fob 64 with key 68. Key fob 64 may have door lock actuation button 72, which locks and unlocks door locks of the vehicle as known, upon activation by operator. Trunk release button 76, which unlocks trunk, may also be provided. These buttons permit control unit 38 to operate in an active lock operation mode. Hence, an operator may lock and unlock the door locks as well as the trunk lock of the vehicle as desired by press each or both buttons.

It is preferred that key fob 64 also have passive lock operation button 80. This button 80 activates control unit 38 to operate in a passive mode whereby locks for each port may be selectively actuated by moving electronic key device 46 within predetermined distance X from each port as described above. This feature thus provides the operator with two modes of lock operation.

As shown in FIGS. 6 and 7, another embodiment of the invention may comprise simply port 84 of a truck, such as a sliding door. Port 84 is secured by lock 88. Control unit 92 communicates with lock 84 and actuates lock 84 between a locked and unlocked position. Proximity sensor 96 communicates with control unit 92, which actuates locking and unlocking of lock 88 when predetermined distance X from port 84 is crossed by electronic key device 46 as described above. Moreover, port 84 may automatically open and close through motorized port subsystem 100. It may open when predetermined distance X is crossed. It may close when predetermined distance Y is crossed. Alternatively, port 84 may open automatically when driver activates the passive operation mode of control unit 92 by activating a passive lock operation button as described above. Port 84 may also be locked and closed automatically by driver who retrieves a package, activates passive operation mode, and walks beyond predetermined distance Y. This embodiment may be further combined with the other control and security features described above.

Combining this embodiment with motorized port subsystem 100 provides a system that greatly improves the efficiency of a cargo carrier. As a driver exits his vehicle on a delivery run, he automatically triggers the unlocking of lock 88 and the opening of port 84 when he reaches predetermined distance X. Alternatively, port 84 may be opened automatically when driver activates passive operation mode. After retrieving his package from the bay, his movement beyond the predetermined distance Y automatically closes port 84 and locks lock 88. Thus, driver may quickly retrieve and deliver package without actively closing and locking port 88.

The aforementioned description is exemplary rather then limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A vehicle port system comprising:
a first port secured by a first lock;
at least a second port secured by a second lock;
a control unit in communication with each of said locks, separately actuating each lock;
an electronic key device;
at least one proximity sensor in communication with said control unit for sensing said electronic key device; and
wherein said control unit actuates said first lock without actuating said second lock when said at least one proximity sensor senses said electronic key device a predetermined distance from said first port and actuates said second lock without actuating said first lock when said at least one proximity sensor senses said electronic key device a predetermined distance from said second port.

2. The vehicle port system of claim 1 wherein said predetermined distance comprises a locking distance that locks any one of said locks if said electronic key device reaches said locking distance and an unlocking distance that unlocks any one of said locks if said electronic key device reaches said unlocking distance.

3. The vehicle port system of claim 1 wherein said electronic key device transmits a key code to said control unit that actuates any one of said locks when said key code matches a security code.

4. The vehicle port system of claim 3 wherein said electronic key device transmits said key code only when activated.

5. The vehicle port system of claim 3 wherein said electronic key device ceases transmitting said key code following actuation of any one of said locks.

6. The vehicle port system of claim 1 including a motorized port subsystem that automatically moves any one of said ports.

7. The vehicle port system of claim 1 wherein said control unit actuates any one of said locks only if any one of said proximity sensors senses said electronic key device by a predetermined time.

8. The vehicle port system of claim 7 wherein said proximity sensors are reactivated to sense for said electronic key device following said predetermined time.

9. The vehicle port system of claim 1 wherein said proximity sensor is a low frequency radio wave transmitter.

10. The vehicle port system of claim 1 wherein said control unit has a transmitter to communicate with said key device.

11. A vehicle port system comprising:
a port secured by a lock;
a control unit controlling actuation of said lock;
an electronic key device;
at least one proximity sensor in communication with said control unit, sensing distance between said electronic key device and said port;
wherein said control unit lo said lock when said electronic key device is sensed a predetermined distance from said port; and
a motorized port subsystem that automatically moves said port.

12. The vehicle port system of claim 11 wherein said predetermined distance comprises a locking distance that locks said lock if said electronic key device reaches said locking distance and an unlocking distance that unlocks said lock if said electronic key device reaches said unlocking distance.

13. The vehicle port system of claim 11 wherein said electronic key device transmits a key code to said control unit that actuates said lock when said key code matches a security code.

14. The vehicle port system of claim 13 wherein said electronic key device transmits said key code only when activated.

15. The vehicle port system of claim 13 wherein said electronic key device ceases transmitting said key code following actuation of said lock.

16. The vehicle port system of claim 11 wherein said motorized port subsystem that automatically moves said port in conjunction with actuation of said lock.

17. The vehicle port system of claim 11 wherein said control unit actuates said lock only if said proximity sensor senses said electronic key device by a predetermined time.

18. The vehicle port system of claim 17 wherein said proximity sensor is reactivated to sense for said electronic key device following said predetermined time.

19. The vehicle port system of claim 11 wherein said proximity sensor is a low frequency radio wave transmitter.

20. A method for controlling a vehicle port;
A. electronically sensing for a key device a distance from a first vehicle port secured by a first lock;
B. electronically sensing for the key device a distance from at least a second vehicle port secured by a second lock; and
C. automatically actuating the first lock without actuating the second lock when the key device is sensed a predetermined distance from the first vehicle port and automatically actuating the second lock without actuating the first lock when the key device is sensed a predetermined distance from the second vehicle port.
